(19) United States
(12) Patent Application Publication
(10) Pub. No.: US 2026/0278079 A1
(43) Pub. Date: Sep. 17, 2026

(54) SYSTEMS AND METHODS OF REDUCING AN IMPACT OF FALSE-POSITIVE DETECTIONS IN A KERNEL

(71) Applicant: Robert Bosch GmbH, Stuttgart (DE)

(72) Inventors: Sekar KULANDAIVEL, Pittsburgh, PA (US); Stefan GEHRER, Pittsburgh, PA (US); Pradeep M. PAPPACHAN, Pittsburgh, PA (US); Sashidhar JAKKAMSETTI, Sunnyvale, CA (US); Shalabh JAIN, Pittsburgh, PA (US); Jorge GUAJARDO MERCHAN, Pittsburgh, PA (US)

(21) Appl. No.: 19/079,652

(22) Filed: Mar. 14, 2025

(51) Int. Cl. G06F 21/55

(52) U.S. Cl. CPC G06F 21/554; G06F 2221/034

(57) ABSTRACT

A computer-implemented method for mitigating effects of false positive detections of ransomware on a computing device within a first network includes reducing, using a kernel executed on the computing device, a detection threshold from a first threshold to a second threshold less than the first threshold, wherein the first threshold is associated with a ransomware detector within a second network, monitoring one or more characteristics of the computing device, detecting a ransomware event based on the one or more characteristics, determining whether a number of the detected ransomware events is greater than or equal to the detection threshold, and, in response to the number of the detected ransomware events being greater than or equal to the detection threshold, performing one or more mitigating actions on the computing device.

### TECHNICAL FIELD

The present disclosure relates to intrusion detection systems, and more particularly to intrusion detections systems configured to detect ransomware attacks.

### BACKGROUND

Ransomware presents a serious threat to modern digital systems, causing substantial financial and operational damage. In recent years, it has become one of the most infamous forms of malware, targeting individuals, governments, and businesses alike. For cybercriminals, ransomware has evolved into a highly profitable enterprise, generating millions in revenue, while for organizations, it poses a significant risk, leading to financial losses that amount to billions of dollars.

### SUMMARY

A computer-implemented method for mitigating effects of false positive detections of ransomware on a computing device within a first network includes reducing, using a kernel executed on the computing device, a detection threshold from a first threshold to a second threshold less than the first threshold, wherein the first threshold is associated with a ransomware detector within a second network, monitoring one or more characteristics of the computing device, detecting a ransomware event based on the one or more characteristics, determining whether a number of the detected ransomware events is greater than or equal to the detection threshold, and, in response to the number of the detected ransomware events being greater than or equal to the detection threshold, performing one or more mitigating actions on the computing device.

Other embodiments include systems, one or more processors or processing devices, or other circuitry configured to implement functions corresponding to the principles of the present disclosure.

### BRIEF DESCRIPTION OF THE DRAWINGS

FIG. 1 shows a block diagram of an example computing device according to some embodiments of the present disclosure;

FIG. 2 generally illustrates an example system configured to implement ransomware detection techniques according to some embodiments of the present disclosure;

FIG. 3 shows an example ransomware detection system according to some embodiments of the present disclosure;

FIG. 4 shows an example implementation of a ransomware detection system according to some embodiments of the present disclosure;

FIG. 5 shows another example implementation of a ransomware detection system according to some embodiments of the present disclosure;

FIG. 6 illustrates steps of an example method for performing ransomware detection according to some embodiments of the present disclosure; and

FIG. 7 illustrates steps of an example method for performing mitigating actions in response to detection of ransomware events according to some embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Ransomware presents a serious threat to modern digital systems, causing substantial financial and operational damage. In recent years, it has become one of the most infamous forms of malware, targeting individuals, governments, and businesses alike. For cybercriminals, ransomware has evolved into a highly profitable enterprise, generating millions in revenue, while for organizations, it poses a significant risk, leading to financial losses that amount to billions of dollars.

While traditional detection methods like signature-based approaches and behavioral analysis have been employed, those approaches often struggle to detect sophisticated ransomware or prevent attacks early enough. Machine learning has improved detection, but still faces challenges from evolving threats.

Further, detection of false positives (e.g., detection of a ransomware attack when a ransomware attack is not actually occurring) and subsequent responses (e.g., attempts to counter or mitigate a ransomware attack) can cause system inefficiencies and delays, data loss, and other disruptions to business operations. As one example, an impacted machine (e.g., computing device) can be shut down (e.g., powered down, halted, etc.) in response to detecting a ransomware attack on that machine. However, a high false positive rate can lead to unnecessary shutdown of machines. Accordingly, various techniques may be used to reduce false positive rates and/or otherwise mitigate detection of false positives. For example, a detection system or agent may be configured to perform additional or more computationally-intensive processing steps or functions (e.g., processing of additional frames of data), such as analyzing a power profile of the machine as described below in an example. In this manner, false detections of ransomware attacks caused by benign processes can be minimized. In these examples, the additional time required to perform these additional steps may allow the ransomware to encrypt larger amounts of data on the machine, rendering the affected files temporarily inaccessible or even unrecoverable.

Accordingly, ransomware detection systems and methods of the present disclosure are configured to reduce the impact of false positive detection using various techniques as described below in more detail. Rather than minimizing or reducing false positives, the techniques described herein can selectively permit a higher false positive rate (and thus a faster response time to potential ransomware attacks) by enabling an agent to intervene and determine whether a machine should continue operating or be halted/shut down. These techniques provide the ability to tolerate false positive detection and potentially recover system operations without shutting down a suspected machine. In some examples, a separate network channel can be added to a ransomware detector to enable monitoring of the ransomware detector and responses of the ransomware detector.

In an embodiment, a monitored machine may include kernel software configured to selectively (1) enable (e.g., cause, provide a notification to, etc.) an agent to move/change a detection threshold prior to software, one or processes, etc. running and/or (2) wait for an agent to intervene upon a potential false positive detection. For example, the detection threshold may correspond to a number of detection events at which a ransomware attack is detected. In one example, if detection events in a predetermined time period (e.g., a sliding window or block of time) are greater than or equal to the detection threshold, a ransomware attack is detected/indicated. In some example implementations of this embodiment, the agent can correspond to: a software initiator (e.g., if the initiator can be available while the software runs/executes); a member of a product security incident response team (PSIRT); and/or any trusted person trained to review and verify a ransomware detection.

In an embodiment, a monitored machine may include kernel software configured to (1) indicate which process or processes were active during a ransomware detection event and pause/halt those processes and (2) slow down (e.g., underclock) the entire machine if a process-specific halt does not change the detection result. The kernel may be configured to inform an agent (e.g., a dedicated machine, process, or computing device and/or a human user) who can simultaneously receive alerts from the ransomware detector (which may be implemented on a separate computing device/machine). The additional data from the kernel can inform an appropriate response/mitigation to the detection event, such as human intervention, a shutdown of the entire machine, etc.

In an embodiment, a system can be configured to tolerate false positive detections by preemptively storing a file before the file is encrypted or overwritten by an encrypted copy under certain conditions. Instead of always storing a file before any encryption or requiring a nearly zero false positive detection rate, this system may be configured to use a slightly higher/increased false positive rate (and thus faster detection) and only store files associated with these detections. Compared to systems that store shadow copies of all files on a machine, this embodiment of the present disclosure can reduce the overhead of this storage mechanism by not storing files when an agent verifies the current software with the system.

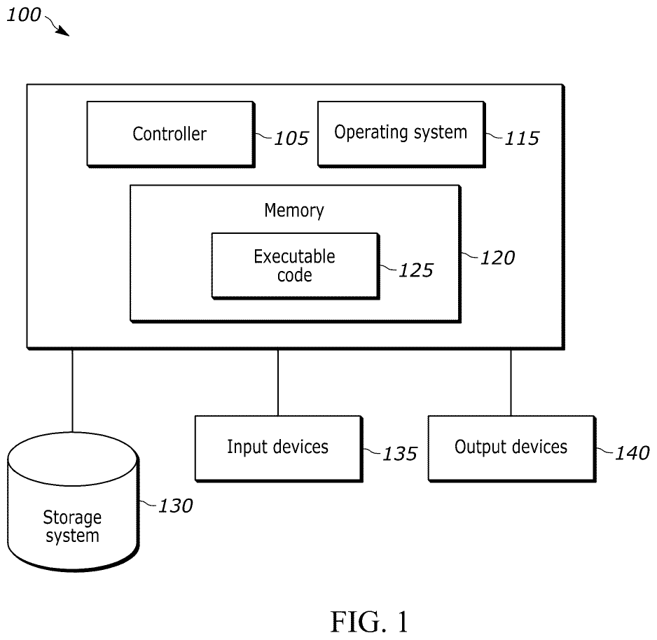

FIG. 1 shows a block diagram of an example computing device 100 according to some embodiments of the disclosure. For example, the computing device 100 may correspond to a targeted machine, a ransomware detector or agent machine, or any other computing device of a ransomware detection system. The device 100 may include a controller 105 that may be, for example, one or more processors, a central processing unit (CPU), a chip or any suitable computing or computational device, an operating system 115, a memory 120, executable code 125, a storage system 130, input devices 135, and output devices 140. The controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the present disclosure.

The operating system 115 may be or may include any code segment (e.g., one similar to the executable code 125 described herein) designed and/or configured to perform tasks involving coordination, scheduling, arbitration, supervising, controlling or otherwise managing operation of the computing device 100, for example, scheduling execution of software programs or tasks or enabling software programs or other modules or units to communicate. The operating system 115 may be a commercial operating system. It will be noted that the operating system 115 may be an optional component (e.g., in some embodiments, a system may include a computing device that does not require or include the operating system 115). For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

The memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. The memory 120 may be or may include a plurality of, possibly different memory units. The memory 120 may be a computer or processor non-transitory readable medium, or a computer non-transitory storage medium (e.g., RAM).

The executable code 125 may be any executable code, e.g., an application, a program, a process, task or script. The executable code 125 may be executed by the controller 105 possibly under control of operating system 115. For example, the executable code 125 may be an application that enforces security in a vehicle as further described herein, for example, detects or prevents cyber-attacks on in-vehicle networks. Although, for the sake of clarity, a single item of the executable code 125 is shown in FIG. 1, a system according to some embodiments of the present disclosure may include a plurality of executable code segments similar to the executable code 125 that may be loaded into the memory 120 and cause the controller 105 to carry out methods described herein. Where applicable, the terms “process” and “executable code” may mean the same thing and may be used interchangeably herein. For example, verification, validation and/or authentication of a process may mean verification, validation and/or authentication of executable code.

The storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in the storage system 130 and may be loaded from the storage system 130 into the memory 120 where it may be processed by the controller 105. In some embodiments, some of the components shown in FIG. 1 may be omitted. For example, the memory 120 may be a nonvolatile memory having the storage capacity of the storage system 130. Accordingly, although shown as a separate component, the storage system 130 may be embedded or included in the memory 120.

The input devices 135 may be or may include any suitable input devices, components or systems (e.g., physical sensors such as accelerometers, tachometers, thermometers, microphones, analog to digital converters, etc., a detachable keyboard or keypad, a mouse, and the like). The output devices 140 may include one or more (possibly detachable) displays or monitors, motors, servo motors, speakers and/or any other suitable output devices. Any applicable input/output (I/O) devices may be connected to the computing device 100 as shown by the blocks 135 and 140. For example, a wired or wireless network interface card (NIC), a universal serial bus (USB) device, JTAG interface, or external hard drive may be included in the input devices 135 and/or the output devices 140. It will be recognized that any suitable number of the input devices 135 and the output devices 140 may be operatively connected to the computing device 100 as shown by the blocks 135 and 140. For example, the input devices 135 and the output devices 140 may be used by a technician or engineer in order to connect to the computing device 100, update software and the like. Input and/or output devices or the components 135 and 140 may be adapted to interface or communicate, with control or other units in a vehicle, e.g., input and/or output devices or the components 135 and 140 may include ports that enable the device 100 to communicate with an engine control unit, a suspension control unit, a traction control and the like.

Embodiments may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as the memory 120, computer-executable instructions such as the executable code 125 and a controller such as the controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the present disclosure may include components such as, but not limited to, a plurality of central processing units (CPU) or any other suitable multi-purpose or specific processors or controllers (e.g., controllers similar to the controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as the computing device 100.

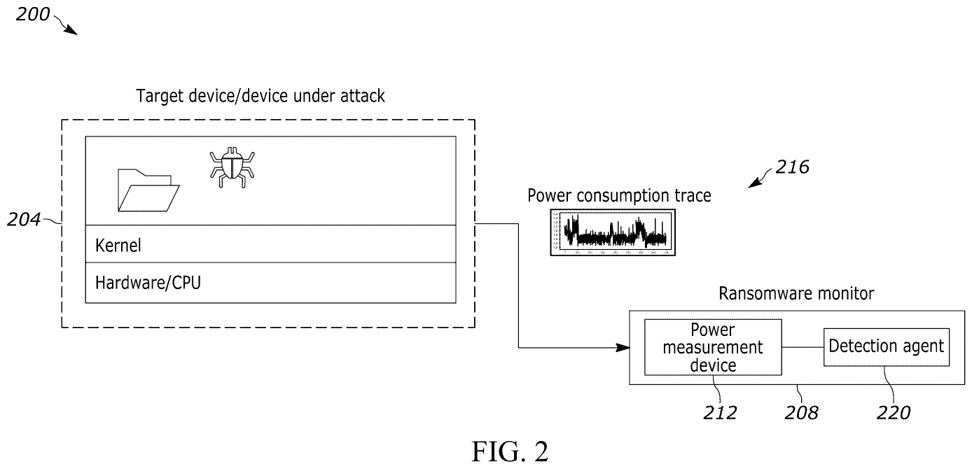

FIG. 2 generally illustrates an example system (e.g., a computing system 200) configured to implement techniques of the present disclosure according to one embodiment. The system and method may include a target device 204 and a ransomware monitor 208 (e.g., a server, cloud computing system, computing device, controller, one or more processing devices, etc. configured to implement ransomware monitor functions as described herein). The target device 204 may be the device under attack. The target device 204 may include various hardware and software components, such as those discussed in FIG. 1. The target device 204 can be any computing device, such as a desktop/PC, mobile phone, server, enterprise high-performance server, industrial control system, IoT device, or automotive microcontroller-generally, any device that relies on a power source, whether from an outlet or battery.

The ransomware monitor 208 is a specialized device configured to perform one or more ransomware detection functions. As one example, the ransomware monitor 208 includes and/or implements a power measurement tool or device 212, such as an oscilloscope or electromagnetic (EM) measurement device, to track power consumption of the target device 204 via a power consumption trace 216 (or EM characteristics, sound, any side-channel information, etc.; the system and embodiments may describe the system for power traces, however any form of signal can be considered as a detection source). The ransomware monitor 208 may include a processor to read and analyze digital power traces and a small storage unit for storing pre-trained ML models that analyze the power data to detect ransomware (e.g., as represented in FIG. 2 by a detection agent 220). The monitor and target device may be physically close (e.g., within a same room, facility or building, etc.) to enable real-time measurement and monitoring.

The system 200 may be configured to assume that all software components on the target device 204 (e.g. including the OS, hypervisor, and driver software/firmware) can be compromised, and that ransomware can operate at any privilege level. Physical adversaries with direct access to the target device 204 may not be considered. The ransomware monitor 208 may be assumed to be trusted and physically unreachable by adversaries or unauthorized parties. For additional security, the monitor can be offline, without network access, to prevent remote attacks. However, if the ransomware monitor 208 is equipped with a secure root of trust, such as a trusted platform module (TPM) or a trusted execution environment (TEE), network communication may be allowed after proper authentication. The system 200 can further enable secure boot and attestation processes to ensure the integrity of the software and models implemented by the monitor 208.

The system 200 is provided as only one example system configured to detect ransomware attacks on a one or more devices. The principles of the present disclosure as described below in more detail may be implemented in other types of systems (e.g., systems configured to detect ransomware attacks using different detection mechanisms). One example system for detecting ransomware attacks is described in more detail in U.S. Pat. Publication No. 2024/0330459, filed on Mar. 31, 2023, the entire contents of which are incorporated herein by reference.

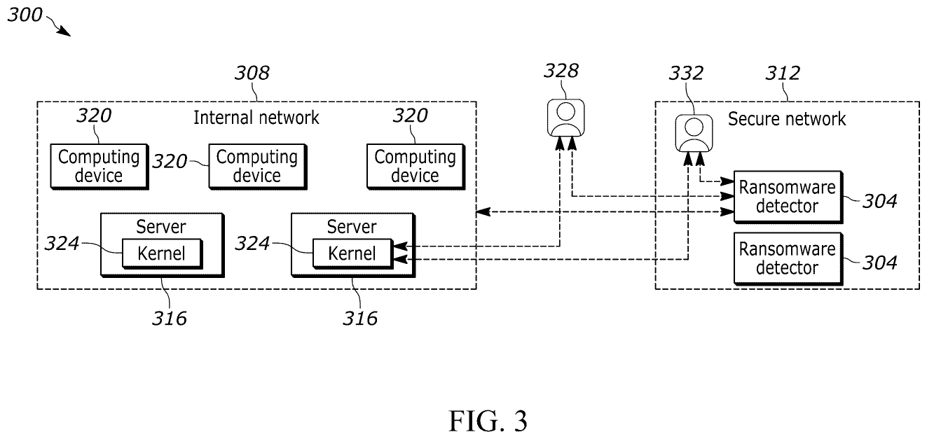

FIG. 3 shows an example ransomware detection system 300 according to the present disclosure. The ransomware detection system 300 may configured to implement one or more of the ransomware detection techniques described below in more detail.

For example, the ransomware detection system 300 includes one or more ransomware detectors 304 configured to detect ransomware events in one or more devices on an internal network 308 using various techniques, such as the power consumption-based techniques described above in FIG. 2 or other techniques. The ransomware detectors 304 may each correspond to: one or more computing devices; processors or processing devices configured to execute ransomware detection functions; software processes or code; and/or other combinations of hardware and software components configured to perform ransomware detection functions. One or more ransomware detectors 304 may be implemented on a same computing device or each of the ransomware detectors 304 may correspond to a different computing device.

The ransomware detectors 304 may be located in or on a secure network 312, such as an out-of-band network. In other words, the ransomware detectors 304 may be external to the internal network 308 containing devices/machines monitored by the ransomware detectors 304. The monitored devices may include, but are not limited to, one or more servers 316 (e.g., corporate servers), computing devices 320 (e.g., personal computers or other computing devices), etc.

In some examples, one or more of the servers 316 and/or the computing devices 320 may include/implement one or more kernels 324 (e.g., an operating system kernel, a build system kernel, etc.), which may be referred to as a kernel on a monitored machine. One or more agents (e.g., an agent 328 with access to both the network 308 and the network 312 and/or an agent 332 within the secure network 312) may receive information regarding processes running/executing on the various servers 316, computing devices 320, etc. (e.g., from a corresponding kernel).

In various examples, it may be desirable for a ransomware detector to be configured to balance the speed of the detection with the amount of data lost prior to a successful detection. Since responses to a ransomware detector may include shutting down a machine, a false positive can result in a critical disruption to business. Considering a desirable configuration and the impact of a false positive, it is likely that such a ransomware detector may sacrifice detection speed with the aim of removing most (if not all) false positives. Unfortunately, as more data is encrypted by ransomware as time goes on (e.g., subsequent to an initial detection), desirable settings for a ransomware detector can be challenging to select.

Accordingly, the ransomware detection system 300 is one example of system configured to implement ransomware detection techniques of the present disclosure to reduce the impact of false positives while maintaining the ability to shut down affected machines in a timely manner.

In one example, one or more kernel or kernel modules (e.g., the kernel 324) of the ransomware detection system 300 may be configured to implement encryption counter and threshold reductions techniques as described below in more detail. In this example, a monitored machine may include kernel software configured to selectively (1) enable (e.g., cause, provide a notification to, etc.) an agent to move/change a detection threshold prior to software, one or processes, etc. running and/or (2) wait for an agent to intervene upon a potential false positive detection. For example, the detection threshold may correspond to a number of detection events at which a ransomware attack is detected/indicated. In one example, if detection events in a predetermined time period (e.g., a sliding window or block of time) are greater than or equal to the detection threshold, a ransomware attack is detected/indicated. In some example implementations of this embodiment, the agent can correspond to: a software initiator (e.g., if the initiator can be available while the software runs/executes); a member of a product security incident response team (PSIRT); and/or any trusted person trained to review and verify a ransomware detection.

For example, to enable faster ransomware detection, the ransomware detector 304 may be set/configured to trigger in response to a smaller number of encryptions instead of a typical load performed by ransomware. As one example, if the ransomware detector 304 is typically set to detect ransomware after 800 encryptions (e.g., file encryptions performed by ransomware), the ransomware detector 304 may be set to provide an alert after only 200 encryptions to prevent the ransomware from encrypting more data. The kernel 324 (e.g., kernel module/software) may be configured to count a number of encryptions within a block of time to identify the potential upcoming encryption load. In this example, if a default counter is set to count 200 encryptions within X time, then an encryption count that approaches 200 encryptions can halt the software so that the ransomware detector 304 does not trigger (i.e., does not shut down the affected machine). Since this count of less than 200 encryptions is lower than the 200 encryptions required to trigger the ransomware detector 304, then the ransomware detector 304 can be set to more sensitive settings (e.g., settings more likely to detect a ransomware/encryption event). With more sensitive settings (and likely higher false positive rate), the kernel 324 may be configured to automatically request that the ransomware detector 304 temporarily reduce a detection threshold. While this automated kernel-detector interaction may be acceptable for one or two system/machine shutdowns, the ransomware detector 304 may be configured to request an agent to intervene before permitting the suspect software to continue. In this manner, the overall impact of ransomware is reduced by effectively rate-limiting the ransomware. In some examples, a PSIRT may monitor the halting/shutdowns and agent request events to more easily detect a widespread ransomware attack (i.e., across multiple machines).

Further, the kernel 324 may be configured to analyze software (e.g., software running/executing on a corresponding machine/computing device) and estimate a potential upcoming encryption load and preemptively request an agent to lower a detection threshold of the ransomware detector 304 based on the estimate of the upcoming encryption load. As the kernel 324 should have access to the running software, the trigger condition (i.e., detected events reaching the detection threshold) could occur before corresponding software begins or while the software is running. Even if the kernel 324 is compromised, the ransomware detector 304 may not lower the detection threshold without a request being sent to an agent who must then verify the request. As a result, agents may be trained to avoid a potentially spoofed request to reduce the detection threshold.

In another example, one or more kernel or kernel modules of the ransomware detection system 300 may be configured to (1) indicate which process or processes were active during a ransomware detection event and pause/halt those processes and (2) slow down (e.g., underclock) the entire machine if a process-specific halt does not change the detection result. The kernel 324 may be configured to inform an agent who can simultaneously receive alerts from the ransomware detector 304. The additional data from the kernel 324 can inform an appropriate response/mitigation to the detection event, such as human intervention, a shutdown of the entire machine, etc.

For example, in response to a ransomware detection event by the ransomware detector 304 having a configuration with increased sensitivity (and, thus, a higher false positive rate), the ransomware detector 304 may be configured to initiate a slowdown of the monitored machine (i.e., without completely halting or powering or shutting down the entire machine). In examples where the monitored machine does not include a kernel or kernel module configured to identify and halt a suspected process, slowing down the entire machine can reduce the impact of a ransomware attack. For example, by slowing down the clock of the suspected machine, the impact of ransomware is reduced as less data is encrypted over time. In the event this detection was a false positive, an agent can be requested to interact and temporarily undo the slowdown of the clock. The network traffic for a suspected machine can also be slowed down or halted to permit further analysis without completely shutting down the machine. In an example, the restoration of the original machine clock speed and network traffic may only occur in response to an agent confirming with the detector that a false positive detection occurred.

In some examples, systems can be configured to tolerate false positive detections by preemptively storing a file from the affected machine before the file is encrypted or overwritten by an encrypted copy. In this manner, files can be backed up prior to an encryption in case the encryption is being performed by ransomware. However, such example require large processing and storage overhead. In another example of the present disclosure, the system 300 can be configured to tolerate false positive detections by preemptively storing a file from the affected machine before the file is encrypted or overwritten by an encrypted copy only under certain conditions, thereby reducing file backup overhead. For example, instead of always storing a file before any encryption or requiring a nearly zero false positive detection rate, this system may be configured to use a slightly higher/increased false positive rate (and thus faster detection) and only store files associated with these detections. Compared to systems that store shadow copies of all files on a machine, this embodiment of the present disclosure can reduce the overhead of this storage mechanism by not storing files when an agent verifies the current software with the system.

As an example, to reduce the potential overhead of these overhead reduction techniques, backups can be kept/retained unless an agent provides input to the ransomware detector 304. Techniques for performing these backups can utilize an existing copy-on-write mechanism together with automated snapshots (e.g., snapshots available on various file systems, such as ZFS, a B-tree file system (Btrfs), etc.) on the target machine so that the encryption is only performed on a copy. For example, the original file can be kept intact in the event a ransomware event is detected in the middle of the file encryption. If there is concern about the size of the backup file, approaches using agent involvement can reduce the storage usage and ensure that all to-be-encrypted files are accessible in the event of a ransomware attack. These files could then be used to restore machines after a detected attack. The machine can use a secure co-processor or a TEE to handle storing these backups and stop storing only if an authenticated agent confirms that the running software is not ransomware. If ransomware is detected, then the new files to replace the previously encrypted files can be generated within a secure enclave and then only released if those backed up files are not ransomware/malware. This approach requires an agent to analyze the backed-up files.

As one example, systems and methods as described herein may be configured to not backup files until one or more conditions are met. For example, rather than automatically beginning to backup files in response to detecting a ransomware event, backup can be triggered in response to a predetermined number of events (e.g., encryption events) being detected (e.g., in response to a number of detected encryptions reaching an encryption threshold). In this manner, the number of backed up files can be significantly reduced.

In an alternative example, the encryption process can be modified so that whenever an encryption request is received, the data to be encrypted is sent to a TEE. The TEE can keep a copy of the encrypted file for a predetermined period until an agent indicates that the encryption process/call was legitimate and not malicious/ransomware. In another variation, virtual machines (VMs) can be created for encryption processes and the VMs may only have read access to data stores. Thus, the VM can always request storage for a copy of the file and then, within the VM, encrypt the file. In this example, stores are not compromised and in principle the system does not need to create a shadow copy of all files, only files that are to be encrypted. It is preferred if the VM runs as a trusted VM (e.g., the VM has been attested by a TEE or the VM itself is a TEE via existing TEE technologies, such as TDX, etc.).

In each of the above examples, the TEE that performs the encryption can be set up during system creation and can be assumed to be created in a secure environment. The TEE can be approved by a trusted agent that has also access rights to the data stored in the TEE.

In still another example, the system 300 can be configured to identify a malicious process using iterative pausing. For example, a malicious process can be identified by iteratively disabling different processes until the malicious process is found/identified. The agent can generate an alert about a potential intrusion and then trigger the pausing (or halting/aborting/shutdown) of a first process. The selection of the selected process can be, for example, based on the running process that causes most I/O traffic, has a highest processor load, and/or has a highest number of encryptions. After disabling the first process, the agent checks whether an intrusion is still detected. If an intrusion is not detected after disabling the first process, then the disabled process can be identified as the malicious ransomware/malware process can remain disabled and subject to further analyzation (e.g., by the agent). If an intrusion is still detected after disabling the first process, then the disabled first process can be re-enabled (e.g., by the agent) and another (e.g., second process) can be disabled. A similar process is performed for the second process (and additional processes, if required) until the malicious process is identified.

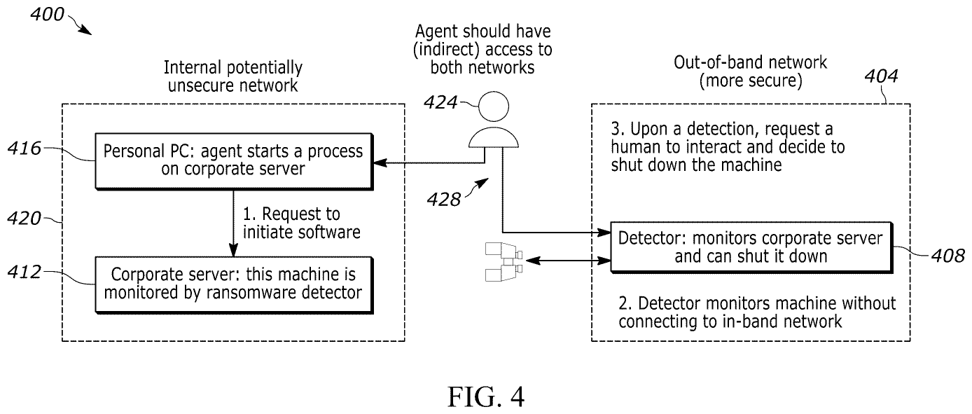

FIG. 4 shows an example implementation of a ransomware detection system 400 according to the present disclosure. In this example, an out-of-band network 404 includes a ransomware detector 408 configured to monitor machines/computing devices (e.g., a corporate server 412, a personal PC 416, etc.) on an internal network 420 for ransomware. The ransomware detector 408 can confer with the agent 424 upon a potential false positive detection. After a trigger condition is met, the ransomware detector 408 can ask an agent to continue the software process or shut down the machine.

To reduce the impact of a false positive and even enable the ransomware detector 408 to be set to detect faster (with a higher false positive rate), the agent 424 can be requested to interact with the ransomware detector 408 in the event of a (potential) false positive. The software initiator (or a trusted set of agents, such as a PSIRT) must be able to communicate with the ransomware detector 408. As shown in FIG. 4, a communication channel 428 enables the agent 424 to communicate with the ransomware detector 408 as the ransomware detector 408 operates outside the potential victim machine. In an example, the agent 424 may have access to both the internal (potentially unsecure) network 420, where ransomware may exist, and the out-of-band network 404 that is more secure and dedicated for communication between the agent 424 and the ransomware detector 408.

The out-of-band network 404 may be a cellular or other type of network that operates outside of the internal network 420. For example, if the target machines operate within a virtual private network (VPN) connected by Wi-Fi and Ethernet, then the ransomware detector 408 can connect to a cellular network owned and operated by a different entity. In this manner, the likelihood that both of the networks 404, 420 are comprised by the same ransomware at the same time is reduced/minimized. The agent 424 can be defined as a person or software/module that initiates software on a monitored machine and/or can interact with the ransomware detector 408 attached to the monitored machine. This dual access can provide additional information to the agent 424 on how to respond to a (potentially false positive) detection.

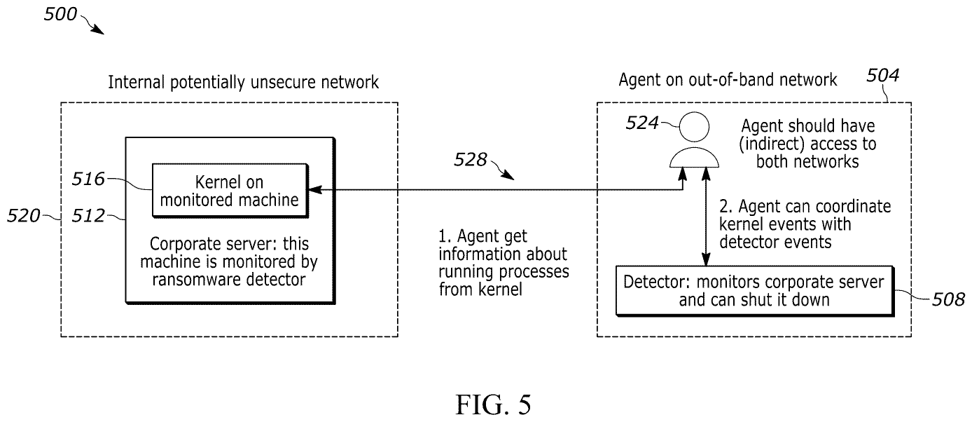

FIG. 5 shows another example implementation of a ransomware detection system 500 according to the present disclosure. In this example, an out-of-band network 504 includes a ransomware detector 408 configured to monitor machines/computing devices (e.g., a corporate server 412 including a kernel 516) on an internal network 520 for ransomware. In this example, an agent 524 on the out-of-band network 504 can verify (e.g., via a channel 528) detection of ransomware by identifying software/processes running on the monitored machine. The kernel 516 (e.g., kernel module/software) on the monitored machine can provide data to the agent 524, who also receives event information from the ransomware detector 508.

In the event that ransomware is triggered by a bot in a compromised network, the agent can verify whether a currently running software/process is ransomware. To enable this verification, the kernel 516 on the monitored machine can report the currently running process to the agent 524. The agent 524 can verify whether a detection was a false positive using various techniques.

In an example system where fast-as-possible ransomware detection is desirable, the ransomware detector 508 can be set to trigger faster (e.g., with a lower detection threshold) with an associated higher-false positive rate. To support this setting, the kernel 516 on the monitored machine can be activated and can report the current process to the agent 524. When a detection occurs, the agent 524 can communicate with the kernel 516 to instruct the kernel 516 to halt the process. This halting can be automatic (e.g., using a software-based agent). The agent 524 can then be prompted to investigate and identify the source, context, and other information about the halted process.

If the kernel 516 is compromised by ransomware, then the ransomware detector 508 can trigger again. By alerting the agent 524 again, the agent 524 can be more confident that the process was actually ransomware and not a false positive. If the ransomware detector 508 does not trigger again, the agent 524 can decide to resume the process and potentially place stricter observation for the monitored machine. Similarly, the agent 524 can request that the software initiator provide feedback to continue the process.

When the ransomware detector 508 is first implemented, the number of false positives may be higher than expected/desired. However, after a plurality of agent verifications, the ransomware detector 508 (e.g., a detector model implemented by the ransomware detector 508) can be trained to avoid/reduce the number false positive detections.

If the agent 524 is implemented as software (e.g., instead of a human), the agent 524 should be implemented in a secure manner since the agent 524 can potentially override a detection result. For example, the agent 524 can be implemented as an artificial intelligence (AI) model (such as a large language model, or LLM) configured to analyze software and other context to confirm that the software is not ransomware and then inform the kernel 516 to permit the software/process to continue. If the security of this software cannot be guaranteed, various techniques can be used for a human agent to verify the detection results of the ransomware detector 508. One or more of these techniques can be used to request that the agent 524 confirm a false positive result.

As one example, CAPTCHA techniques can be used to implement a challenge-response test sent to the software initiator to determine whether the software that triggered the ransomware detector 508 was initiated by a human. The CAPTCHA can be implemented as a popup that appears on the active desktop of the software initiator. The CAPTCHA can be requested prior to running the software on the monitored machine in case the initiator cannot be present while the software runs.

As another example, MFA (multi-factor authentication) techniques can be used. For example, after a trigger condition, the ransomware detector 508 can request the agent 524 to perform MFA. The MFA ensures that the identity of the agent who initiated the software is configured and that it is safe to continue running the software. While MFA is typically used to verify an identity before gaining access to a machine, MFA as implemented in the system 500 can be used to confirm identity after software has started to run. Without a successful MFA, a halted process will not resume.

As another example, PSIRT techniques can be used. For example, for events where the software initiator is unreachable or not responding, the ransomware detector 508 can request a member of the PSIRT to respond and determine a next step for the (potentially) affected machine. Further, if events of multiple ransomware detectors are aggregated by a PSIRT, the events of just a few machines could enable a PSIRT to inform the decision to shut down other machines that did not generate events to prevent ransomware from propagating.

For the CAPTCHA and MFA techniques, the software initiator may be required to be available to respond; otherwise, there may be a delay in the completion of the software. Further, if a potential false positive can be predicted for a given software (e.g., a software that will encrypt several files and then write to disk), the CAPTCHA and MFA techniques can be used to lower the trigger condition (e.g., a detection threshold) of the ransomware detector 508. This approach assumes that the software initiator is trustworthy. The PSIRT can also be used to replace the software initiator. A member of the PSIRT can obtain additional context of the current software from the kernel 516 to aid the PSIRT member in their decision to continue or shut down the machine.

The agent 524 may also have the capability to make an out-of-band request to the ransomware detector 508 to intentionally modify the trigger threshold in case the agent 524 predicts that an incoming software load (e.g., high encryption with file I/O) might be detected as ransomware. The ransomware detector 508 can then communicate with the agent 524 to confirm the expected load, the new trigger conditions, and other necessary information prior to initiating the software on the monitored machine. This option might be needed for software loads that are timely and should not be halted due to potential false positive detection.

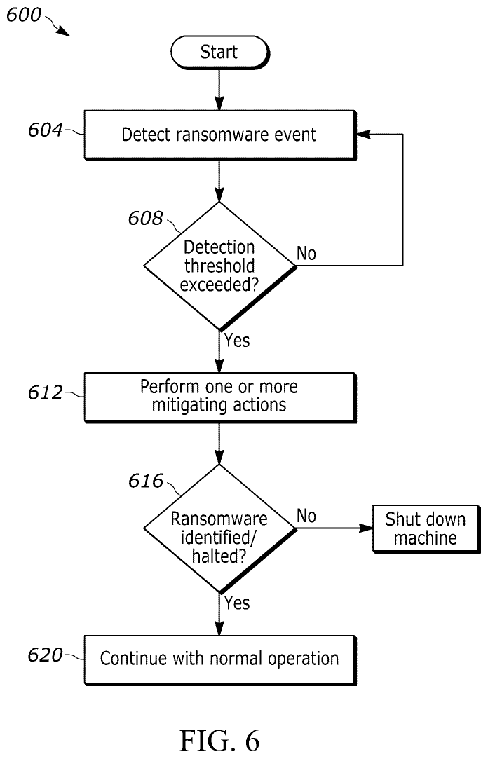

FIG. 6 illustrates steps of an example method 600 for performing ransomware detection according to the principles of the present disclosure. For example, one or more computing devices, processors or processing devices, etc. are configured to execute instructions to implement the method 600, such as one or more of processors of the systems described herein. In an example, the one or more of the systems 300, 400, and 500 are configured to implement all or portions of the method 600.

At 604, the method 600 includes detecting a ransomware event. As used herein, detecting a ransomware event may refer to detecting or measuring one or more characteristics indicative of ransomware file encryption, such as: power measurements as described herein; file access, modifications, or renaming; performance degradation; processor and/or disk usage; network traffic characteristics; and so on. For example, a ransomware detector (e.g., the ransomware detector 304, 408, 508) receives measurements or other data associated with a monitored machine and detects ransomware events using the data.

At 608, the method 600 includes determining whether a number of detected ransomware events (e.g., a number of ransomware events detected in a predetermined period or block of time, sliding window, etc.) exceeds a detection threshold. If true/yes, the method 600 continues to 612. If false/no, the method 600 continues to 604. If no, the method 600 may selectively reset (i.e., set to 0) the number of detected ransomware events (e.g., if the predetermined period has expired), advance the sliding window, etc. In this manner, the method 600 ensures that the number of detected ransomware events exceeds the detection threshold for a selected or calibrated predetermined period prior to advancing to 612.

At 612, the method 600 includes performing, without completely shutting down or otherwise halting operation of the machine on which the ransomware was detected, one or more mitigating actions or functions in accordance with the principles of the present disclosure. These mitigation actions may include, but are not limited to: slowing down the machine/affected processes (e.g., by underclocking the machine); selectively/iteratively halting processes that were active when the ransomware event was detected; selectively modifying a detection threshold associated with a ransomware detector; selectively backing up files; and so on.

As used above in step 612, “shutting down the machine or otherwise halting operation of the machine” may include, but is not limited to, functions such as disabling a network connection of the machine, halting the machine via hardware, disabling disk power, and so on. In other words, shutting down the machine may not be limited to simply powering off the machine but may include various other functions configured to halt processing functions, disk or memory access, etc.

At 616, the method 600 includes determining whether performing the mitigating actions identified and/or halted the ransomware encryption. If true/yes, the method 600 continues with normal operation at 620. If false/no, the method 600 shuts down the entire machine at 624.

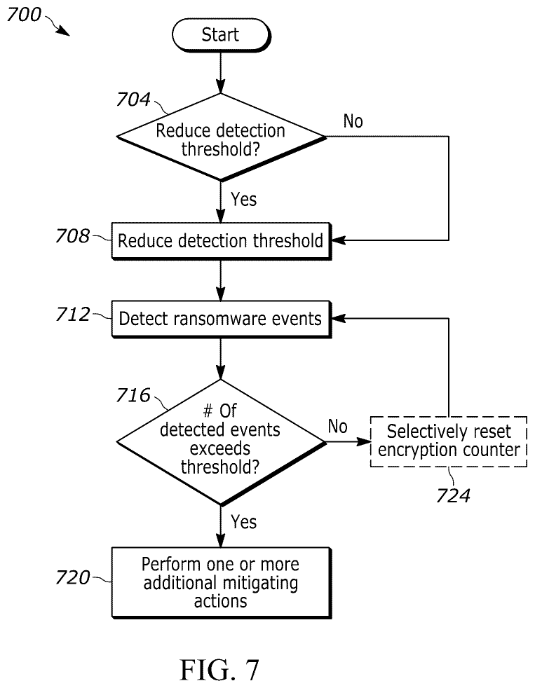

FIG. 7 illustrates steps of one example method 700 for performing mitigating actions in response to detection of ransomware events according to the principles of the present disclosure. For example, one or more computing devices, processors or processing devices, etc. are configured to execute instructions to implement the method 700, such as one or more of processors of the systems described herein. In an example, the one or more of the systems 300, 400, and 500 are configured to implement all or portions of the method 700. For example, the method 700 may correspond to mitigating actions performed at 612 in FIG. 6 as described above.

In the method 700, a monitored machine may include a kernel (e.g., kernel software, a kernel module, etc.) configured to implement an encryption counter and threshold reduction techniques as described above. The kernel may be configured to enable a detection threshold to be moved/changed (e.g., by an agent) prior to software, one or more processes, etc. running and/or wait for external intervention (e.g., by an agent) upon a potential false positive detection.

At 704, the method 700 includes determining whether to reduce/decrease a detection threshold. As one example, the detection threshold may be reduced in response to a determination that a predetermined software process is running or will begin to run. For example, the predetermined software process may correspond to a process known to include encryption tasks. As one example, the detection threshold may be reduced based on a determination of an encryption load of a running processing task (or a processing test schedule/determined to be beginning). If true/yes, the method 700 continues to 708. If false/no, the method 700 may repeat step 704. In other words, in an example, the method 700 may only continue in response to a determining that the detection threshold should be reduced.

At 708, the method 700 includes reducing (e.g., by the kernel implemented on the monitored machine) the detection threshold. For example, a ransomware detector may be normally configured to detect a ransomware attack in response to detection events reaching a first, greater threshold (e.g., 800 detections/encryptions). Conversely, at 704, the detection threshold may be reduced to a second threshold less than the first threshold (e.g., 200 detections/encryptions). Accordingly, the detection threshold implemented by the kernel may be less than the detection threshold of the ransomware detector. In some examples, at 708, the method 700 may further include increasing a sensitivity of the ransomware detector.

At 712, the method 700 includes detecting, by the kernel, ransomware events. For example, detecting ransomware events may refer to detecting or measuring one or more characteristics indicative of ransomware file encryption, such as: power measurements as described herein; file access, modifications, or renaming; performance degradation; processor and/or disk usage; network traffic characteristics; and so on. Detecting the ransomware events may include incrementing an encryption counter implemented by the kernel.

At 716, the method 700 includes determining whether a number of detected events exceeds the (reduced) detection threshold. In some examples, determining whether the number of detected events exceeds the detection threshold includes determining whether the number of detected events in a sliding window or predetermined block of time exceeds the detection threshold. If true/yes, the method 700 continues to 720. If false/no, the method 700 continues to 724.

At 720, the method 700 includes performing one or more mitigating actions. For example, the entire monitored machine may be slowed down. As other examples, one or more software process may be halted, the monitored machine may be shut down, a network connection of the monitored machine may be disabled, one or more hardware components of the monitored machine may be disabled, etc. In still other examples, the one or more mitigating actions may include providing an alert (e.g., to an agent) and/or requesting intervention (e.g., by an agent).

At 724, the method 700 may optionally include selectively resetting an encryption counter prior to continuing to 712. For example, in examples where the method 700 determines whether the number of detected events in a sliding window of time or a predetermined block of time exceeds a threshold, the encryption counter may be reset (e.g., when the block of time expires/cycles) or otherwise adjusted (e.g., adjusted downward when the sliding window of time shifts, causing the number of detected events in the sliding window to decrease).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The various steps and logic performed herein can be executed with non-volatile storage, memory, and processors. Non-volatile storage may include one or more persistent data storage devices such as a hard drive, optical drive, tape drive, non-volatile solid-state device, cloud storage or any other device configured to persistently store information. Processor may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. Memory may include a single memory device or a number of memory devices including, but not limited to, random access memory (RAM), volatile memory, non-volatile memory, static random access memory (SRAM), dynamic random access memory (DRAM), flash memory, cache memory, or any other device configured to store information.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrases “at least one of A, B, and C” and “at least one of A, B, or C” should be construed to mean a logical (A OR B OR C), using a non-exclusive logical OR, and should not be construed to mean “at least one of A, at least one of B, and at least one of C.”

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “a processor” (or, “a processing device,” “a computing device,” and so on) configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

What is claimed is:

1. A computer-implemented method for mitigating effects of false positive detections of ransomware on a computing device within a first network, comprising:
reducing, using a kernel executed on the computing device, a detection threshold from a first threshold to a second threshold less than the first threshold, wherein the first threshold is associated with a ransomware detector within a second network;
monitoring one or more characteristics of the computing device;
detecting a ransomware event based on the one or more characteristics;
determining whether a number of the detected ransomware events is greater than or equal to the detection threshold; and
in response to the number of the detected ransomware events being greater than or equal to the detection threshold, performing one or more mitigating actions on the computing device.

2. The computer-implemented method of claim 1, wherein the one or more mitigating actions include at least one of halting or slowing down a software process of the computing device, slowing down the computing device, powering off the computing device, disabling a network connection of the computing device, halting operation of hardware on the computing device, and disabling power to one or more components of the computing device.

3. The computer-implemented method of claim 1, further comprising, in response to the number of the detected ransomware events being greater than or equal to the detection threshold, at least one of providing a notification to an agent external to the first network and requesting intervention from the agent.

4. The computer-implemented method of claim 3, wherein the agent is enabled to access both the first network and the second network.

5. The computer-implemented method of claim 3, further comprising determining, by the agent, whether the detected ransomware event corresponds to a ransomware attack or a false positive detection.

6. The computer-implemented method of claim 3, wherein the agent is a software agent configured to analyze processes being executed on the computing device and identify false positive detections of ransomware.

7. The computer-implemented method of claim 1, further comprising, prior to reducing the detection threshold, determining, by the kernel, whether to reduce the detection threshold.

8. The computer-implemented method of claim 7, further comprising determining whether to reduce the detection threshold based on a determination of a software process running on the computing device.

9. The computer-implemented method of claim 8, further comprising determining whether to reduce the detection threshold based on an encryption load of the software process running on the computing device.

10. The computer-implemented method of claim 1, further comprising selectively resetting an encryption counter monitoring the number of detection events.

11. The computer-implemented method of claim 10, wherein selectively resetting the encryption counter includes resetting the encryption counter in response to a predetermined block of time expiring.

12. A system for mitigating effects of false positive detections of ransomware on a computing device within a first network, the system comprising:
memory storing instructions; and
a processor configured to execute the instructions, wherein executing the instructions causes the processor to:
reduce, using a kernel executed on the computing device, a detection threshold from a first threshold to a second threshold less than the first threshold, wherein the first threshold is associated with a ransomware detector within a second network;
monitor one or more characteristics of the computing device;
detect a ransomware event based on the one or more characteristics;
determine whether a number of the detected ransomware events is greater than or equal to the detection threshold; and
in response to the number of the detected ransomware events being greater than or equal to the detection threshold, perform one or more mitigating actions on the computing device.

13. The system of claim 12, wherein the one or more mitigating actions include at least one of halting or slowing down a software process of the computing device, slowing down the computing device, powering off the computing device, disabling a network connection of the computing device, halting operation of hardware on the computing device, and disabling power to one or more components of the computing device.

14. The system of claim 12, wherein executing the instructions further causes the processor to, in response to the number of the detected ransomware events being greater than or equal to the detection threshold, at least one of providing a notification to an agent external to the first network and requesting intervention from the agent.

15. The system of claim 14, wherein the agent is enabled to access both the first network and the second network.

16. The system of claim 14, wherein executing the instructions further causes the processor to determine whether the detected ransomware event corresponds to a ransomware attack or a false positive detection.

17. The system of claim 14, wherein the agent is a software agent configured to analyze processes being executed on the computing device and identify false positive detections of ransomware.

18. The system of claim 12, wherein executing the instructions further causes the processor to, prior to reducing the detection threshold, determine, by the kernel, whether to reduce the detection threshold.

19. The system of claim 18, wherein executing the instructions further causes the processor to determine whether to reduce the detection threshold based on a determination of an encryption load of a software process running on the computing device.

20. The system of claim 12, wherein executing the instructions further causes the processor to selectively reset an encryption counter monitoring the number of detection events in response to a predetermined block of time expiring.
